(19) United States
(12) Patent Application Publication
(10) Pub. No.: US 2017/0330166 A1
(43) Pub. Date: Nov. 16, 2017

(54) Customer Tracking System

(71) Applicant: Wal-Mart Stores, Inc., Bentonville, AR (US)

(72) Inventors: Nicholaus A. Jones, Fayetteville, AR (US); Robert J. Taylor, Rogers, AR (US); Aaron J. Vasgaard, Rogers, AR (US); Matthew A. Jones, Bentonville, AR (US); Todd D. Mattingly, Bentonville, AR (US)

(21) Appl. No.: 15/596,053

(22) Filed: May 16, 2017

Related U.S. Application Data
(60) Provisional application No. 62/336,991, filed on May 16, 2016.

(51) Int. Cl. G06Q 20/20; G06Q 30/02

(52) U.S. Cl. CPC G06Q 20/208; G06Q 30/0201

(57) ABSTRACT

In some embodiments, systems, apparatuses, and methods are provided herein useful to track customer movement within a shopping facility. To achieve this, a travel distance is tracked during a shopping trip and collected at or adjacent to a point of sale with an access device. The travel distance can further be correlated to products that were purchased during the shopping trip and, based on the location of the purchased products and the store layout, a travel path for the shopping trip can be estimated.

### CROSS-REFERENCE TO RELATED APPLICATIONS

This application claims the benefit of U.S. Provisional Application No. 62/336,991, filed May 16, 2016, which is hereby incorporated by reference herein in its entirety.

### TECHNICAL FIELD

This invention relates generally to systems for tracking customers within a shopping facility.

### BACKGROUND

The distribution and location of items within a shopping facility can be a difficult decision. Shopping facilities have to decide where to place certain items based in part on popularity, type, and power supply needs, to name a few. Difficulty in finding an item can lead to unnecessarily lengthy shopping trips and frustration in customers. Accordingly, any information on shopping habits can be very helpful when designing a store layout.

### BRIEF DESCRIPTION OF THE DRAWINGS

Disclosed herein are embodiments of systems, apparatuses and methods pertaining to tracking customer movement through a store and using the tracking information to analyze product location. This description includes drawings, wherein:

FIG. 1 is diagrammatic view of a shopping facility in accordance with some embodiments.

FIG. 2 is side diagrammatic view of a cart in accordance with several embodiments.

FIG. 3 is a side diagrammatic view of a point-of-sale location in accordance with some embodiments.

FIG. 4 is a flowchart in accordance with several embodiments.

FIG. 5 is a flowchart in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to track customer movement within a shopping facility in a cost-effective manner. To achieve this, a travel distance is tracked during a shopping trip and collected at or adjacent to a point of sale. Travel distance can be useful in itself to determine whether a shopping trip was efficient or whether a customer traveled a relatively long distance when compared to location size. Advantageously, the travel distance can further be correlated to products that were purchased during the shopping trip. When stocking locations of the purchased products are correlated to the travel distance, a travel path for the shopping trip can be estimated. The travel path can be utilized to analyze product location to increase visibility, increase throughput, and lower shopping trip times.

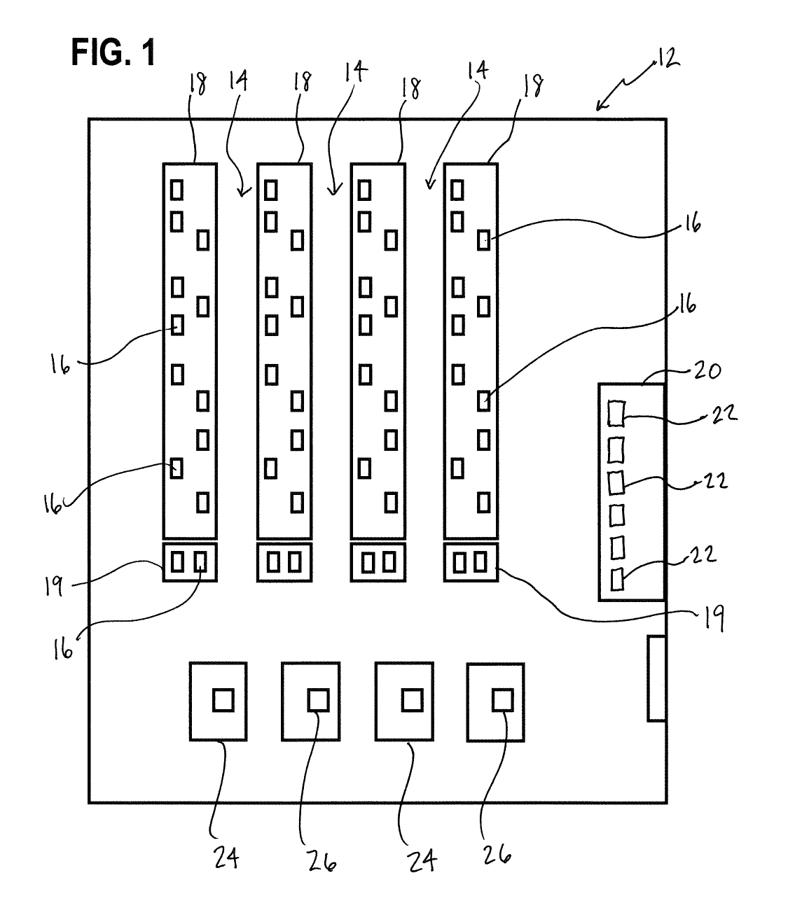

As illustrated in FIG. 1, a shopping facility 12 typically can include a plurality of aisles 14 having products 16 disposed therealong on various displays 18, such as shelving units, coolers, and the like, and on feature locations 19, which can be located at the end of the aisles 14, in free-standing displays, or the like. A cart corral 20 is typically located near an entrance to the shopping facility 12 with carts 22 generally contained therein. As a customer enters the shopping facility 12, the customer can therefore get one of the carts 22 for the shopping trip. Thereafter, the customer will travel through the shopping facility 12 collecting products 16 and proceed to one or more point-of-sale locations 24 having point-of-sale devices 26.

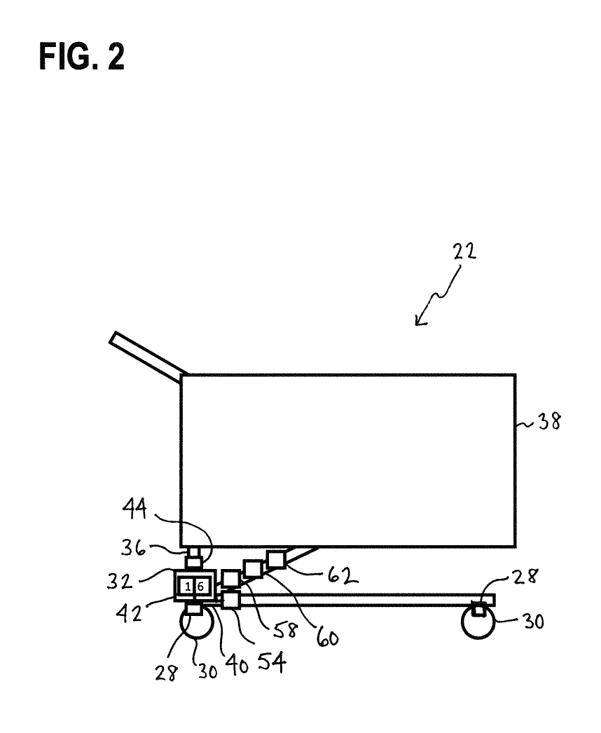

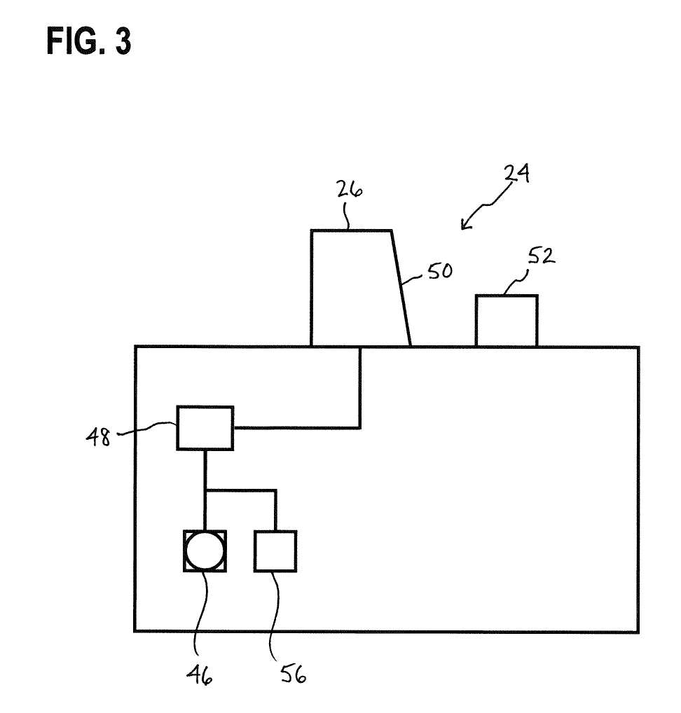

A customer tracking system as described herein, and shown in FIGS. 2 and 3, can advantageously measure a distance traveled by a customer during a shopping trip. Pursuant to this, the carts 22 can have a sensor 28 mounted thereto, such as closely adjacent to one of the wheels or casters 30 thereof. The sensor 28 can be configured to track a number of rotations of the wheel 30 during the shopping trip, which can then be used to determine the distance traveled. By some approaches, the sensor 28 can be a mechanical sensor that operably couples to the wheel 30 to be driven thereby. So configured, rotation of the wheel 30 drives rotation of the sensor 28 or a component within the sensor 28. By other approaches, the sensor 28 can be an electrical sensor that monitors and tracks rotation of the wheel or is driven thereby, such as a hall-effect sensor, a generator, or the like.

The customer tracking system further includes a display 32 mounted to the cart 22 so as to be visible on an exterior 34 thereof. The display 32 is coupled to or forms a part of the sensor 28 and is configured to display the count of the number of rotations tracked by the sensor 28 during the shopping trip. The display 32 can be mounted to any suitable part of the cart 22, such as the legs 36, basket 38, or wheel support structure 40 thereof. The display 32 can also take any suitable form. For example, the display 32 can be a mechanical display having a plurality of numbered wheels or members 42 that are driven to track the count of rotations determined by the sensor 28. With the mechanical display 32 and the mechanical sensor 28, the cart 22 can advantageously be free from electronics and, thus, not require a power source therefor. By another approach, the display 32 can be electrical, having a numerical display, screen, or the like. With approaches using an electrical sensor 28 and/or display 32, a power source 44 can be mounted to the cart 22 at any suitable location and coupled to the sensor 28 and/or display 32 to provide power thereto. The power source 44 can further be rechargeable if desired.

The sensor 28 and/or the display 32 can further be configured to reset after each shopping trip. For example, the sensor 28 and/or display 32 can be configured to reset to zero after a predetermined amount of time has passed, such as after a predetermined time has passed without activity. By one electronic-free approach, the sensor 28 and/or display 32 can include a spring therein that is wound as a result of movement during the shopping trip. Thereafter, when the cart 22 is stationary, the spring can unwind and cause the count to be reset. By another approach, the sensor 28 and/or display 32 can include an electronic timer. As such, the sensor 28 and/or display 32 can include a motion detector configured to begin the timer to reset the count as long as the cart 22 is stationary. In another form, the sensor 28 and/or display 32 can include a reset switch device 45, such as a push button switch. The reset switch device 45 can be positioned and configured to be actuated by another cart 22, when the cart 22 is nested together with the other cart 22. By yet another approach, the sensor 28 and/or display 32 can receive a signal from the point of sale device 26, cart corral 20, or a device at another suitable location to reset the count. If desired, the sensor 28 and/or display 32 can include the electronic timer and motion detection, as described above, that are configured to operate after a next stationary period of a predetermined time in response to reception of the signal.

As shown in FIG. 3, each point-of-sale location 24 can be equipped with an access device that is configured to retrieve or receive information regarding the number of revolutions counted by the sensor 28. By a first approach, the access device is an electronic imager device 46, such as a camera or the like, that is oriented to capture images of the displays 32 mounted to the carts 22, as the carts 22 are advanced through the point-of-sale location 24.

The imager 46 is coupled to a control circuit 48 configured to analyze and process the image and determine the count of revolutions shown on the display 32. The imager 46 can be hardwired to the control circuit 48 or can be configured to communicate wirelessly therewith utilizing any suitable network or protocol. With the wireless communication approach, the imager can include a suitable transmitter or transceiver configured to send signals over the selected network or protocol. Additionally, the term control circuit as used herein refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 48 may be configured (for example, by using corresponding programming stored in a memory as will be well understood by those skilled in the art) to carry out one or more of the steps, actions, and/or functions described herein.

By another approach, the cart 22 can have a radio-frequency identification (RFID) tag or chip 54 mounted thereto that is operably coupled to the sensor 28 and receive readings therefrom. Further, the RFID tag 54 can store the readings from the sensor 28 therein for later retrieval or transmission. By this approach, the access device is a RFID reader 56 configured to read the RFID tag 54 when it is brought within range thereof. As such, the RFID reader 56 can be mounted at or adjacent the point-of-sale location 24. The RFID tag 54 can be provided power from the power source 44 mounted to the cart 22 or can be passive, being activated by the RFID reader 56. The RFID reader 56 is coupled to the control circuit 48 to provide the revolution readings from the RFID tag 54 thereto.

Advantageously, the control circuit 48 can also be coupled to the point-of-sale device or system 26 that is, as commonly understood, configured to receive product information for a purchase transaction. Product information can be entered by user input 50, scanner 52, or any other suitable mechanism. So configured, the control circuit 48 can receive an identification of all products purchased during a shopping trip and associate the products 16 with the distance traveled calculated from the image or the RF tag readings. The control circuit 48 can then retrieve or access product location information for products stocked within the shopping facility 12, which can include blueprints for the location 12, stocking information, and the like.

Based on the distance traveled, the products purchased, and the product location information, the control circuit 48 can then estimate a route taken during the shopping trip. This estimated route can be used to identify whether certain products are difficult to find, whether certain products could be valuably relocated within the store, such as to a featured location, the amount of patronage that products stocked at feature locations 19 receive, which products are often purchased together, and the like. Based on this information, a shopping facility can reposition items within the store to meet consumer demand and provide easier, faster shopping trips for customers. In one example, the control circuit can determine the location of products purchased during the shopping trip. If the distance indicated by the display is such that the customer could not travel to all of the aisle locations where the products are stocked, then the control circuit 48 can deduce that the customer obtained the product 16 from a feature location. With data showing that customers frequently purchased items from the featured location, the shopping facility can deduce that the correct products are stocked thereat.

Further, the control circuit 48 can be configured to receive information from a plurality or all of the point-of-sale devices 26 in the location to compile information for the store. As information and estimated routes for multiple shopping trips are aggregated, the accuracy of the estimated routes can be increased to provide predominant tendencies and products and product locations identified by the tendencies.

So configured, a customer can collect a cart 22 from the cart corral 20, travel throughout the store to collect products 16 for a shopping trip. Meanwhile, the sensor 28 tracks a number of revolutions that one of the wheels 30 makes during the shopping trip and the display 32 displays a count of the number of revolutions. Thereafter, the customer can check-out at one of the point-of-sale locations 24. As described above, as the customer guides the cart 22 through the point-of-sale location 24, the imager 46 can capture an image of the display 32 or the RFID reader 56 can read the RFID tag 54 for the readings stored thereon. Finally, the control circuit 48 can analyze the image or readings to determine a distance traveled during the shopping trip and receive an identification of products purchased during the shopping trip.

Although the system has been described herein with reference to a shopping facility 12, the system is equally applicable to other locations, situations, and circumstances. For example, the sensor 28 along with the display 32 and/or RFID tag 54 can be mounted to carts, vehicles, strollers, and other wheeled conveyances to track revolutions as described herein. Additionally, the cart 22 can include a control circuit 58, a memory 60, and a transmitter 62 having any suitable configuration. In such embodiments, the control circuit 58 can be configured to monitor the revolutions and transmit a signal indicating the travel distance based on the sensor 28. By further approaches, the cart 22 can have a sensor 28 configured to monitor the revolutions of each wheel 30. So configured, the control circuit 58 can extrapolate turns made by the cart 22 due to wheels traveling a different distance from one another. As such, the control circuit 58 can maintain an updated route as the cart 22 is moved. If desired, the control circuit 58 can also transmit the route, such as on demand, at predetermined intervals, and/or when the cart has returned to a home location, such as the point of sale location 24.

In other forms, the system can be used on baggage carts at hotels and the like to track the routes thereof to determine whether the carts 22 were taken to the correct rooms or other locations. In another form, rented baggage carts at airports can be tracked to determine a distance that the cart has been wheeled to know a distance from a home rack and track the route of the cart to help finding lost bags associated with a particular cart. By yet another approach, the system can be used on strollers or carts to track a distance traveled. Further, the stroller or cart can be configured to generate a signal if the system determines that the stroller or cart has traveled further than a predetermined distance. This configuration would be particularly helpful to alert users of a stroller or cart being moved without their knowledge. Further, the stroller or cart can keep an updated route based on the revolutions and send the route to the user. As such, the user will be able to easily find the cart.

In some embodiments, the travel distance is tracked using a sensor disposed adjacent to a wheel of a shopping cart. The sensor can track rotations of the wheel and display a count of the rotations on the shopping cart. Thereafter, the count can be collected at or adjacent to the point of sale, such as by an imaging device.

In some embodiments, a customer tracking system for a shopping facility is described herein that includes: a cart movable on wheels mounted thereto; a rotation sensor mounted to the cart and configured to count a number of revolutions of one of the wheels during a shopping trip; a point of sale device configured to process items for purchase selected during the shopping trip; an access device disposed adjacent to the point of sale device and configured to receive or access information regarding the number of revolutions counted by the rotation sensor; and a control circuit operably coupled to the access device and the point of sale device. The control circuit is configured to: determine the number of revolutions from the information regarding the number of revolutions; correlate the number of revolutions to the items for purchase selected during the shopping trip; access blueprints and product location information for the shopping facility; and estimate a path taken by the cart through the shopping facility based on the number of revolutions, the items for purchase selected during the shopping trip, the blueprints, and the product location information.

By several approaches, the rotation sensor can be a mechanical sensor driven by the one of the wheels. By further approaches, the display includes one or more numbered members driven by the mechanical sensor.

By some approaches, the system further can include a display mounted to the cart and coupled to the rotation sensor, where the display is configured to display the number of revolutions; and wherein the access device comprises an imager oriented to capture an image of the display of the number of revolutions.

By several approaches, the rotation sensor can be an electrical sensor. By further approaches, the system can include a radio frequency identification (RFID) tag coupled to the electrical sensor and configured to receive the number of revolutions therefrom; and wherein the access device can be a RFID reader or receiver configured to receive the number of revolutions from the RFID tag.

By some approaches, the cart can further include a rotation sensor or sensors configured to count the number of revolutions of each of the wheels thereof; and the system can further include a control circuit mounted to the cart and operably coupled to the rotation sensor or sensors, where the control circuit is configured to track turns of the cart by analysis of the number of revolutions of each of the wheels.

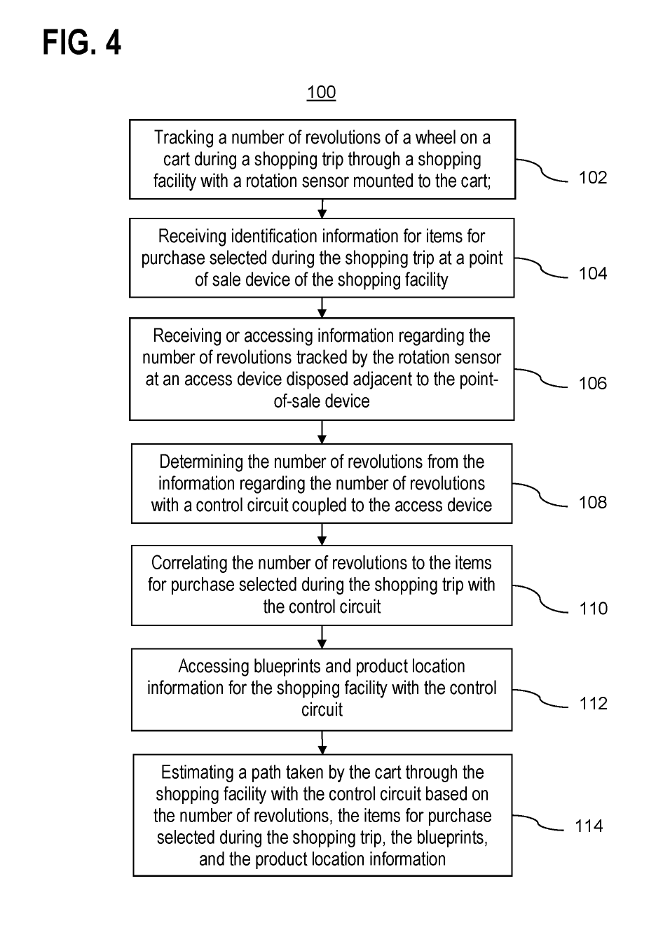

In several embodiments, as shown in FIG. 4, a method 100 for tracking a customer during a shopping trip at a shopping facility is described herein that includes: tracking 102 a number of revolutions of a wheel on a cart during a shopping trip through a shopping facility with a rotation sensor mounted to the cart; receiving 104 identification information for items for purchase selected during the shopping trip at a point of sale device of the shopping facility; receiving or accessing 106 information regarding the number of revolutions tracked by the rotation sensor at an access device disposed adjacent to the point-of-sale device; determining 108 the number of revolutions from the information regarding the number of revolutions with a control circuit coupled to the access device; correlating 110 the number of revolutions to the items for purchase selected during the shopping trip with the control circuit; accessing 112 blueprints and product location information for the shopping facility with the control circuit; and 114 estimating a path taken by the cart through the shopping facility with the control circuit based on the number of revolutions, the items for purchase selected during the shopping trip, the blueprints, and the product location information.

By some approaches, tracking 102 the number of revolutions of the wheel can include tracking the number of revolutions of the wheel with a mechanical sensor driven by the wheel.

By several approaches, the method 100 can further include: displaying the number of revolutions on a display mounted to the cart and operably coupled to the rotation sensor; and capturing an image of the display with an imager mounted to or adjacent the point of sale device; wherein receiving or accessing 106 the information regarding the number of revolutions comprises determining the number of revolutions from the image with the control circuit operably coupled to the imager.

By some approaches, the rotation sensor can be an electrical sensor; and the method 100 can further include receiving the number of revolutions from the electrical sensor at a RFID tag; wherein the receiving or accessing 106 the information regarding the number of revolutions at the access device includes receiving the information regarding the number of revolutions at a RFID reader or receiver.

By several approaches, the method 100 can further includes conglomerating the paths estimated for a plurality of shopping trips with the control circuit to refine estimate accuracy.

By some approaches, the method 100 can further include: tracking a number of revolutions of each wheel on the cart during the shopping trip through the shopping facility with one or more rotation sensors mounted to the cart; and tracking turns of the cart by analyzing the number of revolutions of each of the wheels with a control circuit mounted to the cart.

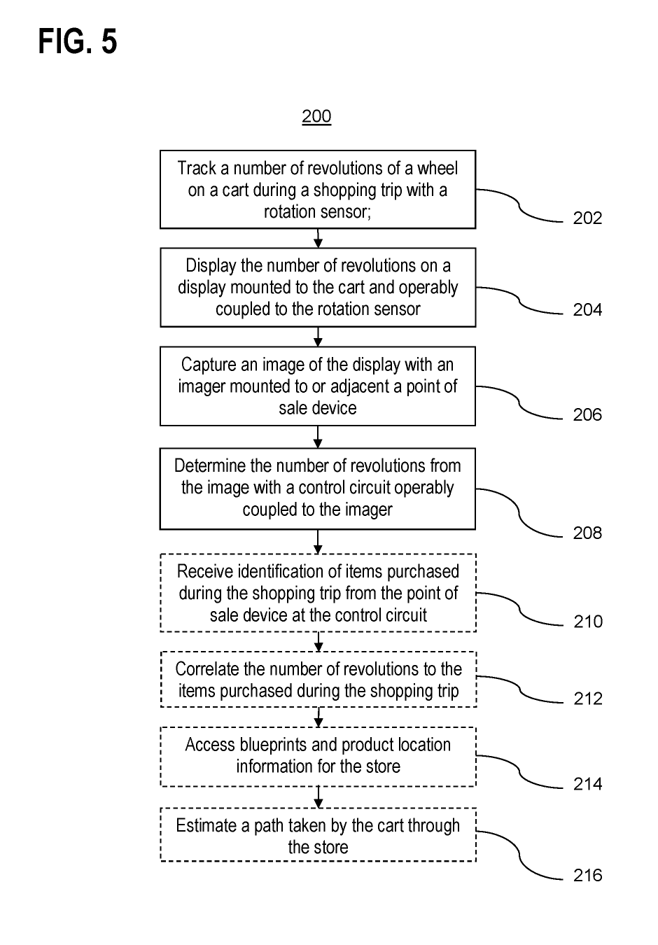

In some embodiments, as shown in FIG. 5, a method 200 for tracking a customer during a shopping trip is described herein that includes tracking 202 a number of revolutions of a wheel on a cart during a shopping trip with a rotation sensor, displaying 204 the number of revolutions on a display mounted to the cart and operably coupled to the rotation sensor, capturing 206 an image of the display with an imager mounted to or adjacent a point of sale device, and determining 208 the number of revolutions from the image with a control circuit operably coupled to the imager.

By some approaches, the method can include receiving 210 identification of items purchased during the shopping trip from the point of sale device at the control circuit. By further approaches, the method can also include correlating 212 the number of revolutions to the items purchased during the shopping trip with the control circuit. By yet further approaches, the method can include accessing 214 blueprints and product location information for the store, and estimating 216 a path taken by the cart through the store based on the number of revolutions, the items purchased, the blueprints, and the product location information with the control circuit. Additionally, the method can include conglomerating the paths estimated for a plurality of shopping trips with the control circuit to refine estimate accuracy.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A customer tracking system for a shopping facility, the system comprising:
a cart movable on wheels mounted thereto;
a rotation sensor mounted to the cart and configured to count a number of revolutions of one of the wheels during a shopping trip;
a point of sale device configured to process items for purchase selected during the shopping trip;
an access device disposed adjacent to the point of sale device and configured to receive or access information regarding the number of revolutions counted by the rotation sensor; and
a control circuit operably coupled to the access device and the point of sale device and configured to:
determine the number of revolutions from the information regarding the number of revolutions;
correlate the number of revolutions to the items for purchase selected during the shopping trip;
access blueprints and product location information for the shopping facility; and
estimate a path taken by the cart through the shopping facility based on the number of revolutions, the items for purchase selected during the shopping trip, the blueprints, and the product location information.

2. The system of claim 1, wherein the rotation sensor comprises a mechanical sensor driven by the one of the wheels.

3. The system of claim 2, wherein the display comprises one or more numbered members driven by the mechanical sensor.

4. The system of claim 1, further comprising a display mounted to the cart and coupled to the rotation sensor, the display configured to display the number of revolutions; and
wherein the access device comprises an imager oriented to capture an image of the display of the number of revolutions.

5. The system of claim 1, wherein the rotation sensor comprises an electrical sensor.

6. The system of claim 5, further comprising a radio frequency identification (RFID) tag coupled to the electrical sensor and configured to receive the number of revolutions therefrom; and
wherein the access device comprises a RFID reader or receiver configured to receive the number of revolutions from the RFID tag.

7. The system of claim 1, wherein the rotation sensor includes a reset switch configured to be actuated and reset the count in response to the cart nesting in an adjacent cart.

8. The system of claim 1, wherein the rotation sensor is configured to reset the count after a predetermined amount of time has passed.

9. The system of claim 1, wherein the control circuit is further configured to conglomerate the paths estimated for a plurality of shopping trips to refine estimate accuracy.

10. The system of claim 1, wherein the cart is free from electronics.

11. The system of claim 1, wherein the cart further comprises a rotation sensor or sensors configured to count the number of revolutions of each of the wheels thereof; and further comprising a control circuit mounted to the cart and operably coupled to the rotation sensor or sensors, the control circuit configured to track turns of the cart by analysis of the number of revolutions of each of the wheels.

12. A method for tracking a customer during a shopping trip at a shopping facility, the method comprising:
tracking a number of revolutions of a wheel on a cart during a shopping trip through a shopping facility with a rotation sensor mounted to the cart;
receiving identification information for items for purchase selected during the shopping trip at a point of sale device of the shopping facility;
receiving or accessing information regarding the number of revolutions tracked by the rotation sensor at an access device disposed adjacent to the point-of-sale device;
determining the number of revolutions from the information regarding the number of revolutions with a control circuit coupled to the access device;
correlating the number of revolutions to the items for purchase selected during the shopping trip with the control circuit;
accessing blueprints and product location information for the shopping facility with the control circuit; and
estimating a path taken by the cart through the shopping facility with the control circuit based on the number of revolutions, the items for purchase selected during the shopping trip, the blueprints, and the product location information.

13. The method of claim 12, wherein tracking the number of revolutions of the wheel comprises tracking the number of revolutions of the wheel with a mechanical sensor driven by the wheel.

14. The method of claim 12, further comprising:
displaying the number of revolutions on a display mounted to the cart and operably coupled to the rotation sensor; and
capturing an image of the display with an imager mounted to or adjacent the point of sale device; and
wherein receiving or accessing the information regarding the number of revolutions comprises determining the number of revolutions from the image with the control circuit operably coupled to the imager.

15. The method of claim 14, wherein the displaying the number of revolutions comprises driving numbered members visible on an exterior of the cart with the sensor.

16. The method of claim 12, wherein the rotation sensor comprises an electrical sensor; and further comprising receiving the number of revolutions from the electrical sensor at a RFID tag;
wherein the receiving or accessing the information regarding the number of revolutions at the access device comprises receiving the information regarding the number of revolutions at a RFID reader or receiver.

17. The method of claim 12, further comprising resetting the number of revolutions.

18. The method of claim 12, further comprising conglomerating the paths estimated for a plurality of shopping trips with the control circuit to refine estimate accuracy.

19. The method of claim 12, further comprising moving a stocking location of a product based on the estimated path.

20. The method of claim 12, further comprising:
tracking a number of revolutions of each wheel on the cart during the shopping trip through the shopping facility with one or more rotation sensors mounted to the cart; and
tracking turns of the cart by analyzing the number of revolutions of each of the wheels with a control circuit mounted to the cart.
